(19) United States
(12) Patent Application Publication
(10) Pub. No.: US 2013/0060733 A1
(43) Pub. Date: Mar. 7, 2013

(54) METHOD AND QUERYING AND CONTROLLING DATABASE

(71) Applicant: Zhonghui Wu, Guangzhou (CN)

(72) Inventor: Zhonghui Wu, Guangzhou (CN)

(73) Assignee: GUANGZHOU CCM INFORMATION SCIENCE & TECHNOLOGY CO., LTD., Guangzhou, Guangdong (CN)

(21) Appl. No.: 13/577,890

(22) PCT Filed: Apr. 26, 2011
(86) PCT No.: PCT/IB2011/000890

§ 371 Date: Aug. 8, 2012

(30) Foreign Application Priority Data
Apr. 23, 2010 (CN) 201010159575.X

(51) Int. Cl. G06F 17/30

(52) U.S. Cl. 707/609; 707/773; 707/E17.014

(57) ABSTRACT

The present invention discloses a method for querying and controlling a database, particularly, a method for identifying and anti-identifying in the database, and a method for querying an association model in the database in a recursion manner. The present invention further discloses a method for displaying the query result obtained through the query method.

### FIELD OF THE INVENTION

The present invention relates generally to a method for querying and controlling a database, and more particularly to a method for identifying and anti-identifying in the database, and a method for querying an association model in the database in a recursion manner.

### BACKGROUND OF THE INVENTION

Conventional Recursive Query Technology

The present database technology has quite a lot of techniques of querying and controlling two-dimensional database, a method for RTN (Recursive transient network) querying and controlling conventional two-dimensional database is: keywords are processed recursively by decision diagrams preset for two-dimensional database, and described by self-nested and self-connected total operation of the whole decision diagrams, meanwhile the keywords after each keyword are selected finitely.

The method above is for conventional two-dimensional database, while if it is for querying and controlling relational model of multi-dimensional database, drawbacks existed in the query method above as follow: (1) Conventional RTN only performs statement description for decision diagram network of attribute dimension (X dimension) took individual association as hierarchy and parallel individual dimension (Y dimension) distinguished with individual types in conventional two-dimensional database, however, because correlation dimension (Z dimension) and time dimension (W dimension) between entities are existed in the multi-dimensional database, the multi-dimensional database can not be described by the conventional RTN method. (2) Results queried by the conventional RTN method only are “some thing happens to some individual at some time”, “comment”. While these information can not be queried if several things happens to this individual at the same time and these things are overlapped (other dimensions are associated). (3) The conventional RTN describes simply and exactly various difficulty levels in a query code with query statement, and builds an improved access plan. It is still needed to make a difficulty levels description and establish own access technique if the difficulty level is very low in a query code, while SQL is the optimal access plan for the query code with very low difficulty level. The RTN has no need to do any operation, on the contrary, performing these operations will influence performance and speed. (4) As alluded in the problem (3), RTN describes simply and exactly various difficulty levels with query statement, and builds an improved access plan. Thus, the RTN needs to analyze the data structure. The analysis time needed will be much long, thereby influence the query speed if there are more related tables or related keywords (there are lots of related tables of the query statement).

### SUMMARY OF THE INVENTION

In order to solve the problems in the prior art, the present invention provides a method for querying and controlling an association model in the multi-dimensional database in a recursion manner and a method for displaying the query result. The present invention further provides identifying and anti-identifying techniques used in the database.

According to a first aspect of the invention, it provides a method for identifying and anti-identifying used in the database, said database contains individuals, the individuals are divided logically into principals and receptors.

The identifying step comprising inserting, updating and deleting the information of the principals;

The anti-identifying step comprising: 1) querying the information of the receptors in the database; 2) forming information needed to apply to the receptors according to the information of the principals if the receptors are queried, and inserting, updating and deleting the formed information for the receptors according to the inserting, updating and deleting of the information of the principals for the principals; 3) If the receptors are not found in the database, inserting information corresponding to the receptors in the individual table, and then inserting the corresponding information into some field of the corresponding row of the receptors.

Preferably, wherein the step of forming information needed to apply to the receptors comprises the following steps: querying states occurred to the principals by the receptors (that is reverse states) in the state storage module, and adjusting the locations of receptors and principals according to the queried the states occurred to the principals by the receptors, and combining the states with fixed information in a preset order, so as to form information needed to be inserted in some field of the corresponding row of the receptor.

According to the second aspect of the invention, it provides a method for identifying and anti-identifying entity tables in the database, the entities corresponding to the entity tables are divided logically into principals and receptors.

The identifying step comprising: storing, updating or deleting the identifiers of associated entities associated with entities in the entity tables in associated entity module of the entity table corresponding to principals.

The step of anti-identifying entity tables corresponding to receptors may comprising: searching entity tables corresponding to said associated entities through identifiers of the associated entities, if corresponding entity tables are searched, then storing, updating or deleting identifiers of the entities in the associated entity modules of the entity tables corresponding to the associated entities, if corresponding entity tables are not searched, storing or updating operations are made in the associated entity modules of the entity tables, then creating entity tables for the associated entities, and storing or updating identifiers of the entities in the associated entity modules of the entity tables created for the associated entities.

According to the third aspect of the invention, it provides a method for identifying state tables in the database, comprising: inserting states in state storage modules, if there are reverse states corresponding to the states, inserting the reverse states in state storage modules, then storing, updating or deleting states occurred by the main entities and the associated entities in the state tables in the associated state module of the state table, and then storing, updating or deleting occurring time of the states in the time-dimensional module of the state tables, wherein the state storage modules are defined in the database to store states occurred by the entities themselves, each state occurred between entities and reverse state corresponding to each state occurred between entities.

The step of anti-identifying state tables comprising: searching state tables corresponding to said associated entities through identifiers of the associated entities and searching reverse states in state storage modules, if corresponding state tables and matched reverse states are searched, then storing, updating or deleting the states occurred by the main entities and the associated entities in the associated state modules of the state tables corresponding to the associated entities using searched reverse states, and storing, updating or deleting occurring time of the states in the time-dimensional module of the state tables corresponding to the associated entities, if corresponding state tables are not searched, storing or updating operations are made in the associated entity modules of the state tables of the main entities, then creating state tables for the associated entities, and storing or updating the states occurred by the main entities and the associated entities in the associated state modules in the state tables created for the associated entities using searched reverse states, and storing or updating occurring time of the states in the time-dimensional module of the state tables corresponding to the associated entities.

Preferably, the anti-identifying step may be automatically proceeded following the identifying operation.

According to a fourth aspect of the invention, it provides a method for querying associated models in the database included associated models, which comprises the following steps: 1) sending query instructions for the entity and association model by a user; 2) judging whether the entity is stored in a node storage module, if not, returning a null query value, if yes, then entering step 3); 3) judging whether there exists a node having a first-level associated with the node that corresponds to the entity, if not, returning non-association query value, if yes, then querying recursively in the recursive query module.

Preferably, wherein, the step of recursion query, comprises the following steps: a) querying the first-level association node of the node corresponding to the entity, reading the node ID and numbering each association of the first-level, wherein, association level is assigned value 1; b) generating an association string according to the node ID, association level and association number, and then storing the string in a storage; c) judging whether there exist lower level recursion, if yes, then enter step d), if not, then enter step e); d) querying the first-level association node of the node corresponding to the association entity associated with the association level, reading the node ID and numbering each association of the level, wherein association level is assigned association level+1; e) reading the string in the storage, and generating a string matrix.

Preferably, whereinafter completing the recursive query, transmitting the string matrix is to a display module.

Preferably, wherein, judging whether there exist lower level recursion can be achieved by querying whether the first-level association node of the node corresponding to the association entity associated with the association level is existed.

According to a fifth aspect of the invention, it provides a method for displaying the query result obtained through the database query method as described in claims 6-9, comprises the following steps: setting display elements corresponding to storage elements in the node storage module, meanwhile said display elements are recorded in the node storage module, therein said storage elements contain node identifiers, associated levels, numbers for associations in each level; finding the display element matched with each storage element in the node storage module according to storage elements recorded in the data matrix after the data matrix of recursive query is obtained; displaying the display elements, so as to display the associated model represented by string matrix.

### BRIEF DESCRIPTION OF THE DRAWINGS

FIG. 1 schematically illustrates the multi-dimensional database module according to an embodiment of the invention.

FIG. 2 is a flowchart of identifying and anti-identifying according to an embodiment of the invention.

FIG. 3 schematically illustrates the node storage modules according to an embodiment of the invention.

FIG. 4 schematically illustrates the association storage modules of entity tables according to an embodiment of the invention.

FIG. 5 is a flowchart of recursion query method of database according to an embodiment of the invention.

FIG. 6 schematically illustrates the relational model according to an embodiment of the invention.

### DETAILED DESCRIPTION OF ILLUSTRATED EMBODIMENTS

Conventional SQL Server, Oracle databases are all belong to two-dimensional databases, different information is recorded in the database in event process way, the storage pattern is “someone did something at some time”, and the information record charts between each other are associated by some key column, such as somebody, something etc. Therefore the conventional databases only have two dimensions: 1. the entity attribute dimension, means that what attributes entity A has, and what thing it did at what time (X dimension); 2. the entity dimension, that is the summary of all entity A, entity B, entity C (Y dimension).

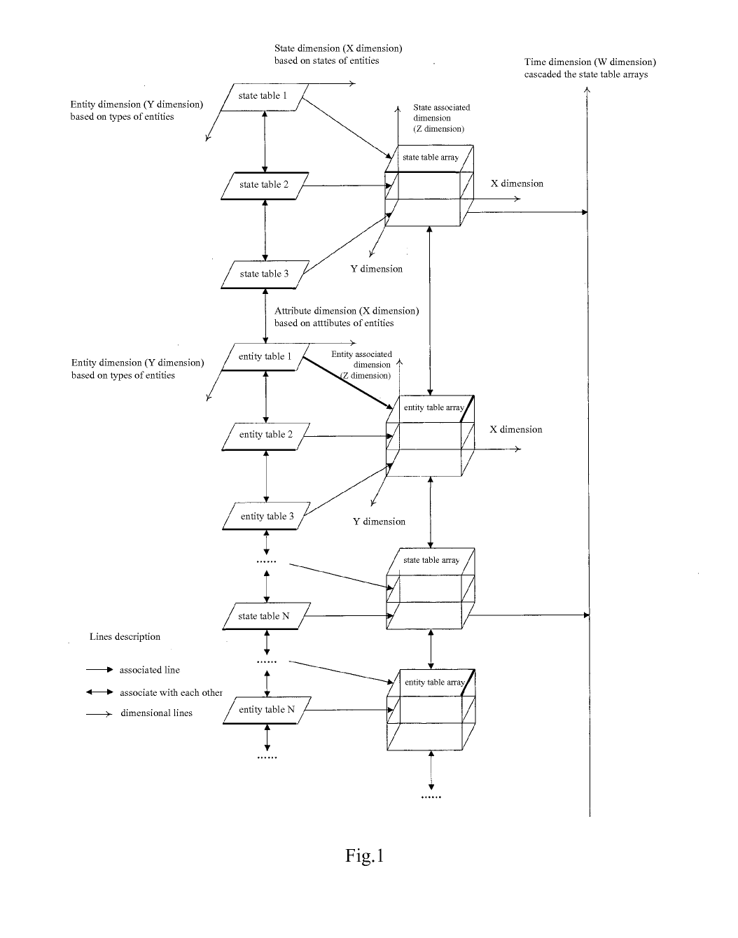

As shown in FIG. 1, entity table modules and state table modules are separately defined when the multi-dimensional database is built. The entity table module is comprised of uncounted entity tables (refer to table 1), each entity table records the information and related attributes of the same type entities, meanwhile the association is established among the entity tables, so that the scattering entity tables are connected by the association dimension; in addition, the state table module is comprised of uncounted state tables of entities (refer to table 2), each state table records the occurring state and time of the entities, meanwhile the association is established between the state and entity tables, and between the different state tables by entity identifiers, and associated with timeline according to occurring time of the entity state. Therefore, besides have attribute (state) dimension (X dimension) based on attributes of the entities and entity dimension (Y dimension) based on types of the entities, the multi-dimensional database also have entity (state) association dimension (Z dimension) obtained by cross-identifying entities and time dimension (W dimension) cascaded the state table arrays in the state table modules.

TABLE 1
Structure of the entity tables in the multi-dimensional database

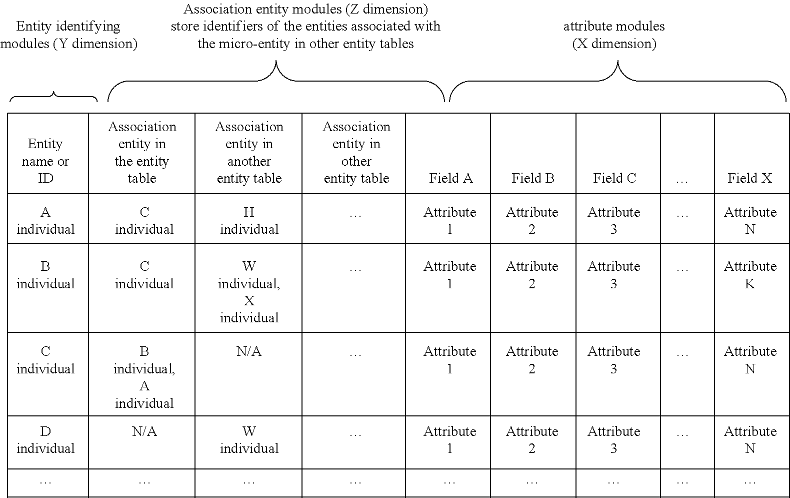

TABLE 2
Structure of the state tables in the multi-dimensional database

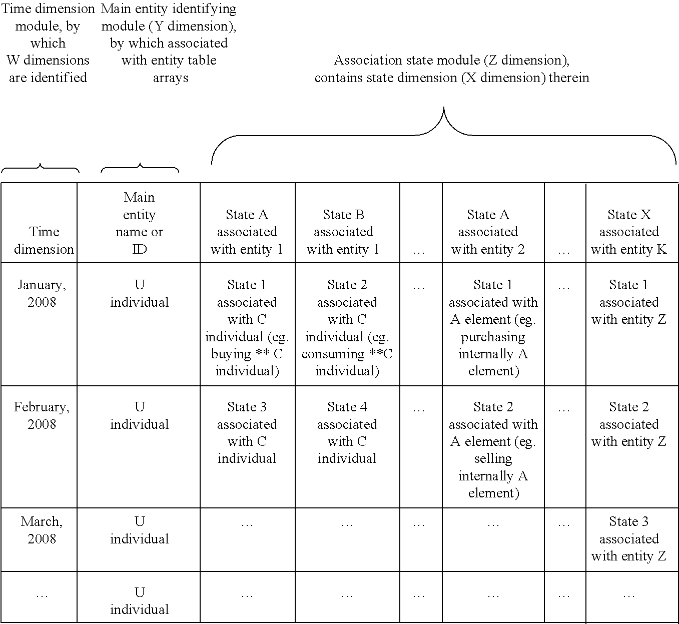

Therefore, the basic difference of the multi-dimensional database is that can save ever-changing multi-dimensional information in optimized manner, thereby save storage resource. Furthermore, the multi-dimensional database also avoid heavy and complicated updating and maintaining workload when multi-dimensional information are saved in conventional method, while only need to modify the state of related entities at some time cross-section, then updating and maintaining of database can be achieved, that is updating database is needed only if event changes happen to entities.

The present invention provides a method for querying and controlling a specific multi-dimensional association model in the multi-dimensional database in a recursion manner, which is improvement based on the conventional two-dimensional RTN querying method, wherein besides X dimension and Y dimension, the association dimension (Z dimension) and the time dimension (W dimension) are queried and displayed with display module.

Specific implementation steps and key points include the following aspects.

1. Identifying and Anti-Identifying Technology

Two new dimensions are inserted in the multi-dimensional database, one is the association dimension (Z dimension) between individuals, which is the new dimension obtained by cross-identifying the entity table module and the state table module; another is time dimension (W dimension), which associates with all state tables, besides the attribute dimension (X dimension) of entities and the parallel entity dimension (Y dimension) distinguished with entity types in conventional two-dimensional database. Identifying and anti-identifying technology not only apply to two-dimensional database, but also apply to identifiers of the association dimension and time dimension.

Since the source data identifying technique in present invention is anti-generated automatically, the management method is very simple relative to conventional two-dimensional data technique. When one of the identifiers in the entity module is modified, the entity identifiers in another table will also be changed automatically according to generating of the automatic anti-identifiers.

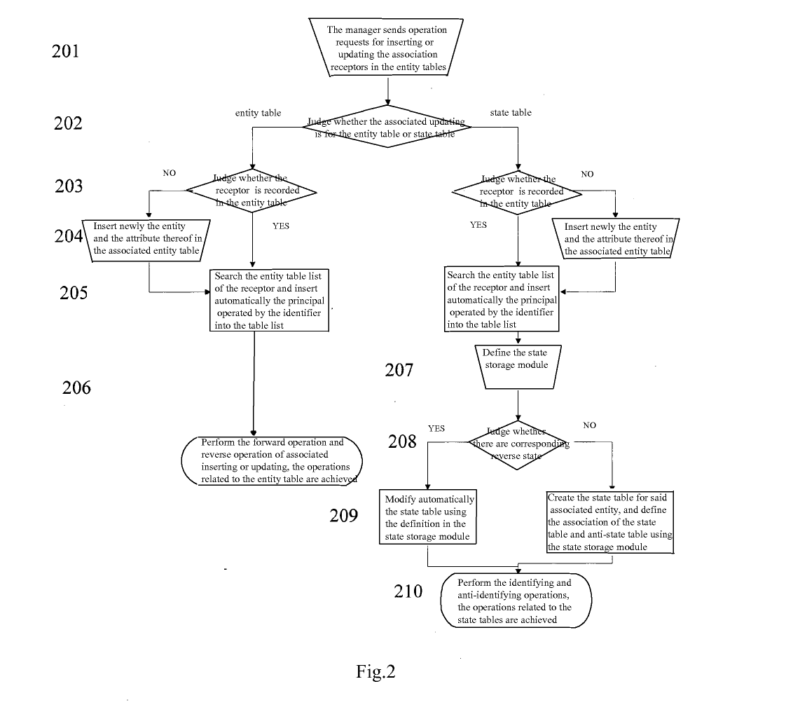

The specific implement process of identifying and anti-identifying is shown in FIG. 2.

The manager sends operation requests for inserting or updating the association receptors in the entity tables (step 201).

Firstly, database will determine whether users operate the entity table or state table (step 202), will be divided to the following two cases: the manager performs operation of modifying associated entity B (receptor B) in the table of the entity A (principal A), the system searches entity list from database and achieve this associated modification in the way that require user to select receptor (step 203), after select, In addition, the system will search automatically the associated information of the associated receptor (the entity B in the above example) of the step of operation, and insert automatically receptor of the table in the entity table, meanwhile commit it to the manager so as to confirm the anti-identifying work. If it is not found that the receptor exists in the database in the step of search, then the user is required to insert the information corresponding to the receptor in the entity table (step 204), in order to guarantee that the anti-identifying operation can be achieved successfully.

Performing the forward direction operation and reverse operation of associated insert or update, the operations related to the entity table are achieved (step 206).

Defining the State Storage Module (Step 207).

Judging whether there are corresponding reverse state (step 208) or not, if yes, then modify automatically the state table using the definition in the state storage module, if not, then create the state table for said associated entity, and define the association of the state table and anti-state table using the state storage module (step 209).

Performing the identifying and anti-identifying operations, the operations related to the state tables are achieved (step 210).

Since the state table itself also associates with the entity table, inserting or updating the receptor in the state table of entity A is relatively similar with the anti-identifying step of the entity table, wherein identifying and anti-identifying in the entity table are also needed. The difference is that a time dimension is existed in the state table while is not existed in the entity dimension, and the system associates the time of the state table of the receptor. Furthermore, since the state association in the state table is more complex than the association between entities, besides identifying entities in anti-identifying of the state table, the states in the state table are needed to be define initially and matched, in order to resolve complex state associated model and time dimension. The specific implemented method is as follow:

A state storage module is built for the state dimension (X dimension) in the state table in the design, and the system manager is required to define and match state and reverse state in the module, called state definition and reverse state definition. If “buying” state in the module is inserted, meanwhile “selling” state is anti-identified. After matching states, corresponding states can be selected directly in the state storage module when the state table is managed, the system will also match automatically the states, in order to achieve the purpose of identifying and anti-identifying.

Although only identifying and anti-identifying of inserting and updating operations is illustrated in FIG. 2, the invention is not limited to that. And it is understood by those skilled in the art that delete operation can also realize identifying and anti-identifying based on the solution above.

The present invention provides a method for identifying and anti-identifying entity tables in the database, the entities corresponding to the entity tables are divided logically into principals and receptors. The identifying step may comprising: storing, updating or deleting the identifiers of associated entities associated with entities in the entity tables in associated entity module of the entity table corresponding to principals.

The step of anti-identifying entity tables corresponding to receptors may comprising: searching entity tables corresponding to said associated entities through identifiers of the associated entities; if corresponding entity tables are searched, then storing, updating or deleting identifiers of the entities in the associated entity modules of the entity tables corresponding to the associated entities; if corresponding entity tables are not searched, storing or updating operations are made in the associated entity modules of the entity tables, then creating entity tables for the associated entities, and storing or updating identifiers of the entities in the associated entity modules of the entity tables created for the associated entities.

The step of identifying state tables may comprising: inserting states in state storage modules; if there are reverse states corresponding to the states, then inserting the reverse states in state storage modules, storing, updating or deleting states occurred by the main entities and the associated entities in the state tables in the associated state module of the state table, and then storing, updating or deleting occurring time of the states in the time-dimensional module of the state tables, wherein, the state storage modules are defined in the database and to store states occurred by the entities themselves, each state occurred between entities and reverse state corresponding to each state occurred between entities. For example, if the state is “purchasing”, then the corresponding reverse state is “selling”. The step of anti-identifying state tables may comprising: searching state tables corresponding to said associated entities through identifiers of the associated entities and searching reverse states in state storage modules; if corresponding state tables and matched reverse states are searched, then storing, updating or deleting the states occurred by the main entities and the associated entities in the associated state modules of the state tables corresponding to the associated entities using searched reverse states, and storing, updating or deleting occurring time of the states in the time-dimensional module of the state tables corresponding to the associated entities; if corresponding state tables are not searched, storing or updating operations are made in the associated entity modules of the state tables of the main entities, then creating state tables for the associated entities, and storing or updating the states occurred by the main entities and the associated entities in the associated state modules in the state tables created for the associated entities using searched reverse states, and storing or updating occurring time of the states in the time-dimensional module of the state tables corresponding to the associated entities.

What described above is the identifying and anti-identifying scheme of multi-dimensional database which has associated individual modules and associated state modules. While in the common database which did not comprised the associated modules defined above, for example, the database shown in table 3 which did not comprised the associated modules in table 1 and 2, data in the table are stored scatteredly. Such table is more general in various database used now. In such table, if the state of some individual is modified in table 3, for example, “state 1 is occurred with C individual in January 2008 (such as, purchasing **C individual)” is inserted in some field of the corresponding row of individual U, then the system will search individual C from database, and if the individual C is searched, “state 1′ is occurred with U individual in January 2008 (such as, selling **C individual)” is inserted in some field of the corresponding row of individual C, the information, such as, time and principal “for example, U” (the individual whose information are amended earlier (corresponding to identifying operation) may be called the principal) and the like, may be copied to some field of the corresponding row of individual C. The state corresponding to each occurred state may be predefined (for example, the corresponding state of “purchasing” is “selling”) and stored in special module (such as state storage module), so that the state occurred to the principal by the receptor (such as “selling”) can be queried in the table according to the state occurred to the receptor by the principal (such as “purchasing”), and the locations of receptors and principals are adjusted according to the state occurred to the principal by the receptor, and are combined with fixed information, such as aforementioned time and the like, in the preset order, thereby forming the information “for example, state 1′ is occurred with U individual in January 2008 (such as, selling **C individual)” needed to be inserted in some field of the corresponding row of the receptor (the individual whose information are changed with the change of other information of individual amended earlier (corresponding to anti-identifying operation) may be called “receptor”). If the receptor is not found in the database after search, then the corresponded information of the receptor are inserted in the individual table, and the corresponding information (for example, states occurred to the receptor and the principal in the above way) are inserted in some field of the corresponding row of the receptor.

With regard to the case of updating, for example, amending “state 1 is occurred with C individual in January 2008 (such as, purchasing **C individual)” to “state 2 is occurred with C individual in February 2008 (such as, consuming **C individual)”, then the information (for example, “state 2 is occurred with U individual in February 2008 (such as, providing **C individual)”) are inserted in some field of corresponding row of the receptor on the basis of the modified information according to the step described above.

With regard to the case of deleting, for example, deleting “state 1 is occurred with C individual in January 2008 (such as, purchasing **C individual)”, then the corresponding information (for example, “state 1 is occurred with U individual in January 2008 (such as, selling **C individual)”) may be deleted from some field of corresponding row of the receptor (such as C).

TABLE 3
The structure of table in general database

| individual | state A | state B | . . . | state X |
|---|---|---|---|---|
| U | state 1 is occurred | state 2 is occurred | . . . | state 3 is occurred |
| individual | with C individual in | with D individual in | | with Z individual |
| | January 2008 (such | February 2008 (such | | in March 2008 |
| | as, purchasing **C | as, consuming **D | | (such as, selling |
| | individual) | individual) | | **Z individual) |
| V | . . . | . . . | . . . | . . . |
| individual | | | | |
| W | . . . | . . . | . . . | . . . |
| individual | | | | |
| . . . | . . . | . . . | . . . | . . . |

In conclusion, for a general database, said database contains individuals, the individuals are divided logically into principals and receptors. The identifying step comprising inserting, updating and deleting the information of the principals; while the anti-identifying step comprising: inserting, updating and deleting the corresponding information of the receptors related to the information of principals corresponding to inserting, updating and deleting of information of principals. The reason why the individuals are divided logically into principals and receptors is that roles of the principals and receptors are determined with respect to the causation of modifying and being modified, the individuals modified earlier are called the principals, and the individuals whose states needed to be modified correspondingly due to the changing of states of the individuals modified earlier are called receptors. Therefore, in some one of identifying and anti-identifying processes, some individuals are the principals, while the individuals associated with them are the receptors, but the associated individuals may be modified earlier in another modifying, thus the individuals are called principals in another modifying.

Specifically, the anti-identifying step comprising: 1) querying information of the receptors in the database; 2) forming information needed to apply to the receptors according to the information of the principals if the receptors are queried, and inserting, updating and deleting the formed information for the receptors according to the inserting, updating and deleting of the information of the principals for the principals; 3) if the receptors are not found in the database, inserting information corresponding to the receptors in the individual table, and then inserting the corresponding information into some field of the corresponding row of the receptors. Specifically, the step of forming information needed to apply to the receptors comprises: querying states occurred to the principals by the receptors (those are reverse states) in the state storage module, and the locations of receptors and principals are adjusted according to the queried state occurred to the principal by the receptor, and combining the states with fixed information in a preset order, so as to form information needed to be inserted in some field of the corresponding row of the receptor.

Wherein the anti-identifying step may be automatically proceeded following the identifying operation.

A method for identifying and anti-identifying in the entity table with associated entity modules, the state table with associated state modules and time dimension, and the general database table without associated module, is described above. However, various combinations, replacements, additions and deletions may be made to technical features described in each specific embodiment without departing from the broader spirit and scope of the invention.

In order to query the database associated by the identifying and anti-identifying technique, node storage module is defined in the invention. The node storage module is used to read the entity table model have associated by the identifying and anti-identifying technique in the database, then each entity is recorded in the node storage module as the node, and each node is identified, for example, according to ID or name. And then associated modes are identified according to the associated dimension (Z dimension) in the multi-dimensional database, thereby node association model is built and recorded in the node storage module.

In order to display the query results, display elements corresponding to storage elements, such as node identifiers, associated levels and numbers for associations in each level and the like, may be set in the node storage module, meanwhile said display elements are recorded in the node storage module. So that related display elements can be called according to the matched relationship of the display elements and node identifiers, types of associated models, numbers of associated layers and levels, and be displayed. The method for recursive query in the invention will be described in detail below.

(1) Building of the Node Association Model

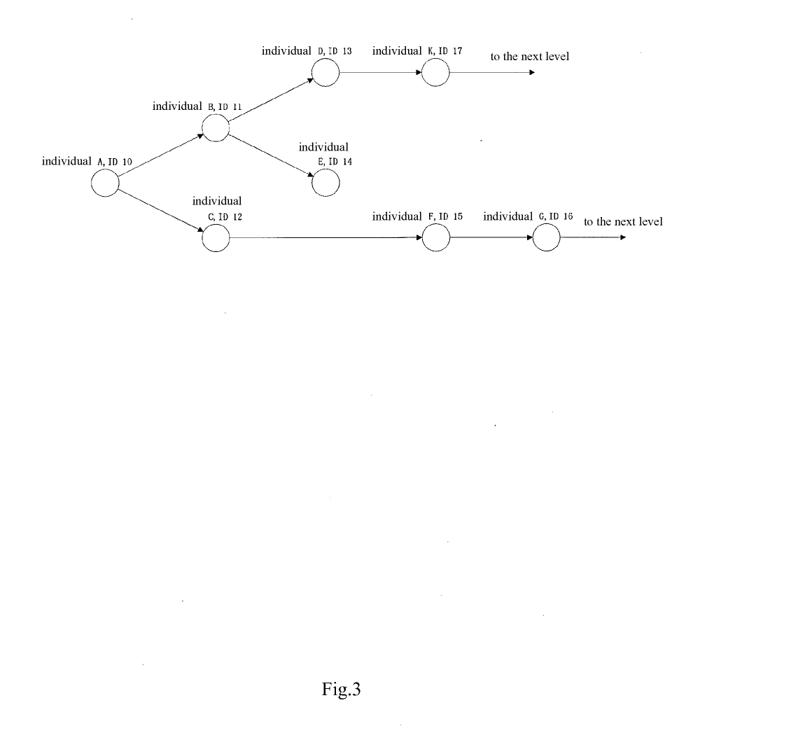

In the invention, the node association model is the model correlated between individuals formed by the associated modules in the entity table and/or the state table in the database (for example, associated entity module and/or associated state module). Take building some kind of association model for example, as shown in FIG. 3, suppose the individual A is took as the beginning, the entity table matrix built in the multi-dimensional database is as follow:

(1) Individual A: associated with individual 8, individual C

(2) Individual B: anti-identified individual A, associated with individual 0, individual E

(3) Individual C: anti-identified individual A, associated with individual F

(4) Individual D: anti-identified individual B, associated with individual K

(5) Individual E: anti-identified individual B, associated with individual F

(6) Individual F: anti-identified individual C, individual E, associated with individual G

After the entity table matrix is built, the system will read automatically 8 entities in the matrix, and treat them as nodes, match them with different node ID in order to be identified. Taking the location of the individual A as the beginning, the system searches the associated level of other nodes and individual A, for example, the individual B, C associate directly with individual A, so they belong to the first level, the individual D, E associate with individual A through individual B, so they belong to the second level, and so on, then multilayer association may be generated.

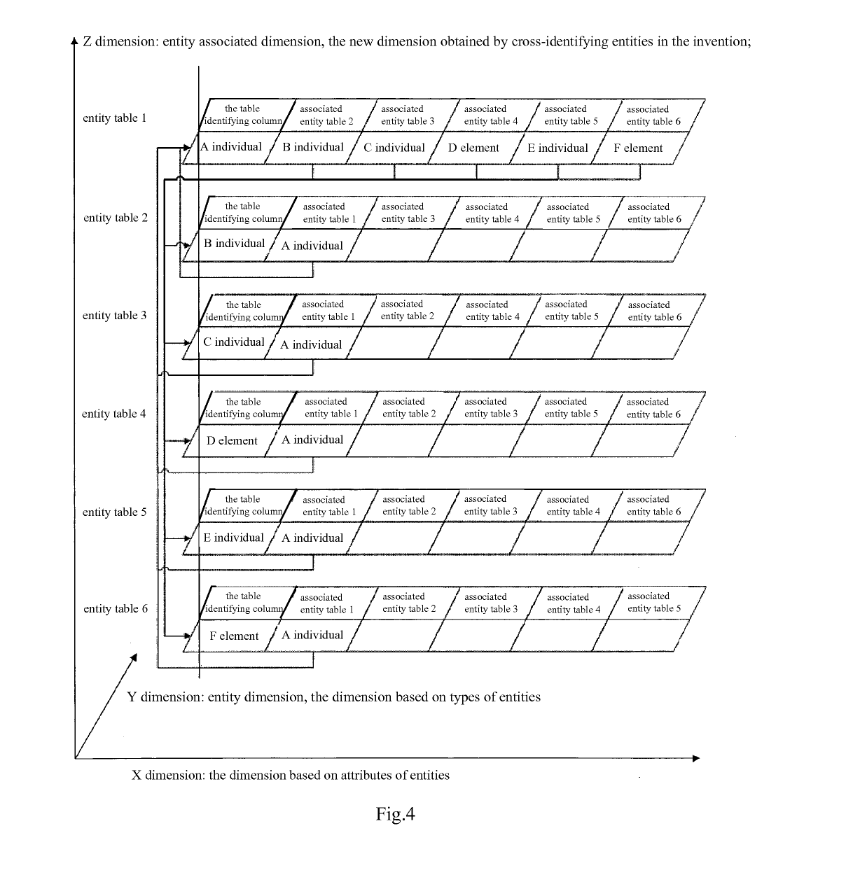

As shown in FIG. 4, the multilayer association among entities is illustrated schematically, it will be appreciated that the association model used by the entity is often much more complex than this model, for example, relates to more nodes, with more layers of association between nodes. As shown in the figure, X dimension is based on attributes of entities, and Y dimension is based on types of entities. In the invention, entities are associated in each entity table by introduced associated entity module, these entity tables can be connected according to these associations, so a new dimension is formed: entity associated dimension (Z dimension). These entity tables become three-dimensional entity table array modules as shown in FIG. 4 by associating said associated modules defined between entities.

(2) The Type of the Association Model

Since a variety of data are existed in the multi-dimensional database, as well as a variety of associated ways, comprising different associated models of the entity table module and the state table module. A single association model can not satisfy a variety of associated models between entities in the multi-dimensional database. For example, the association of upstream raw materials, downstream products is existed between products in market production, the different levels of extension can be forward upstream and downstream; as another example, the different levels of associations also are existed between other produced entities and social entities. The dividing of associated ways is called the type of associated model.

In the invention, the association model will be divided into many types. The association model is separately defined to entity attribute association and entity state association according to defined entity table module and state table module, if necessary, each kind of association therein can be subdivided to several association models according to the difference between the entity attribute and the entity state. Likewise, the same entity can also be used to the different types of associated models.

After types of the association models are defined, the different types of association models will be matched with the corresponding association model ID and be recorded in the database.

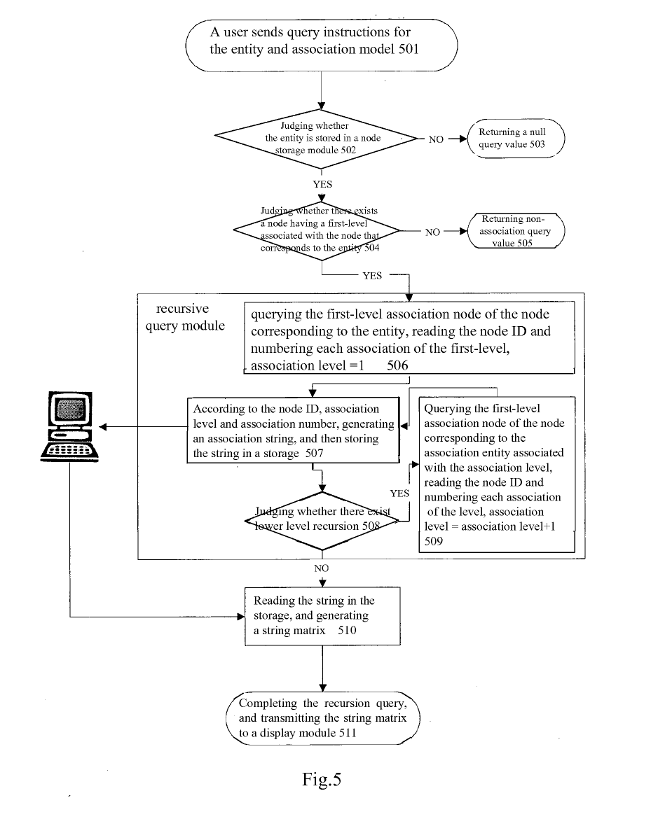

In the invention, after the association models are built, all of models are stored in the database in the form of table list. When user chooses to search the information of some entity in practical operation, the database will perform the process of recursive query. The detailed process of recursive query is shown in FIG. 5, the figure shows a method for querying association models in the database contained association models.

Firstly, the system searches the corresponding node ID of the entity in the node storage module by matching, then queries recursively the last level or next level of node ID through identified associations between nodes. The recursive query is querying all associated lines associated a node ID, also querying the association level in each line. Finally, after the querying of associated lines and the querying of levels are achieved, the system will generate data matrixes according to each associated line and the association level in each associated line, and responds them to the displaying module in order to display query result, then the recursive query is achieved.

Specifically, a Method for querying associated models in the database included associated models is shown in FIG. 5. In step 501, a user sends query instructions for the entity and association model; in step 502 Judging whether the entity is stored in a node storage module, if not, returning a null query value in step 503, if yes, then enter step 504. In step 504, judging whether there exists a node having a first-level associated with the node that corresponds to the entity, if not, returning non-association query value in step 505, if yes, then querying recursively in the recursive query module. Certainly, the recursive query can be used to query association models, for example, association models of entity table and state table in the multi-dimensional database, which are formed according to the identifying and anti-identifying technique in the invention. For example, association models of entity table and state table may be formed according to the identifying and anti-identifying technique in the invention.

In the recursion query module, contains cycle steps 506-509. Specifically, In the step 506, querying the first-level association node of the node corresponding to the entity, reading the node ID and numbering each association of the first-level, wherein, association level is assigned value 1; in the step 507, according to the node ID, association level and association number, generating an association string, and then storing the string in a storage, in the step 508, judging whether there exist lower level recursion, if yes, then enter step 509, if not, then enter step 510. Wherein judging whether there exist lower level recursion can be achieved by querying whether the first-level association node of the node corresponding to the association entity associated with the association level is existed. In the step 509, querying the first-level association node of the node corresponding to the association entity associated with the association level, reading the node ID and numbering each association of the level, association level is assigned association level+1, and return to step 507. In step 510, reading the string in the storage, and generating a string matrix.

In step 511, completing the recursion query, and transmitting the string matrix to a display module. It will be evident to one of ordinary skill in the art that additions, replacements and deletions may be made without departing from the broader spirit and scope of the invention. For example, if the displaying result is not needed, then it is not necessary to transmit the string matrix generated in the recursive query to a display module.

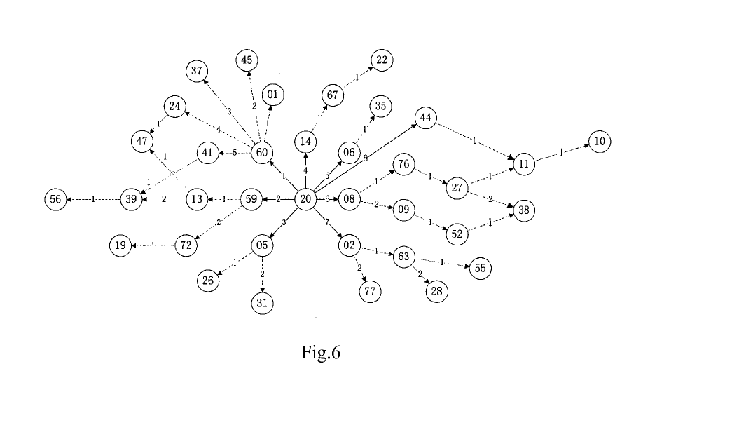

The following example relates to query entity A (the node ID corresponds to 20) and the association model 2 (the relational model as shown in FIG. 6). Therein, the circles with numbers represent nodes, the arrows represent associations, the numbers in the arrows represent serial numbers of the associations.

Step 1: Entity A is matched with node ID 20 read by the system, and query instructions are sent to node storage module.

Mode ID=2; Search? Node=20

Step 2: The system query the first layer association for node ID 20, return exist instruction, enter next step of recursive query.

Step 3: Recursion start, nodes whose node ID is 20 through reading have 8 direct associated nodes; return associated node ID of this associated level, the node 20 and the associated number of this associated level, which are identifying strings:

The first layer of recursion: Recursion 1|60̂20̂1|59̂20̂2|05̂20̂3|14̂20̂4|0̂20̂5|08̂20̂6̂02̂20̂7|44̂20̂8|

It can be seen from the string that the first level associations exist separately between node 20 and nodes 60, 59, 05, 14, 06, 08, 02, 44, and the numbers of associations between them and node 20 in the associated level are separately 1-8. Numbering associations can be proceeded according to the size of associated degree between nodes. Certainly, it is not limited to sort characters in the generated string in the way above, other ways are possible, for example various permutation and combination of the node 20, the associated node ID of this associated level and the associated numbers of this associated level etc.

By that analogy, there are 5 layers of recursion, separately return the following string:

The second layer of recursion: Recursion 2|01 ̂60̂1|45̂60̂2|37̂60̂3|24̂60̂4|41̂60̂5|13̂59̂1|72̂59̂2|26̂05̂1|31̂05̂2|67̂14̂1|35̂06̂1|76̂08̂1|09̂08̂2|63̂02̂1|77̂02̂2|11̂44̂1|

The third layer of recursion: Recursion 3|47̂24̂1|39̂41̂1|47̂13̂1|39̂13̂2|19̂72̂1|22̂67̂1|27̂76̂1|52̂09̂1|55̂63̂1|28̂63̂2|10̂11̂1|

The fourth layer of recursion: Recursion 4|56̂39̂1|1 1̂27̂1|38̂27̂2|38̂52̂1|

The fifth layer of recursion: Recursion 5|10̂11̂1

Step 4: The system judges the sixth layer of recursion, returns null query value, the recursive query ends. Finally the system generates string matrix and deliver it to the displaying module. The generated string matrix is showed as follow.

Mode ID = 2; Search?Node = 20

| Recursion 1 | Recursion 2 | Recursion 3 | Recursion 4 | Recursion 5 |
|---|---|---|---|---|
| 60\hat{ }20\hat{ }1 | 01\hat{ }60\hat{ }1 | 47\hat{ }24\hat{ }1 | 56\hat{ }39\hat{ }1 | 11\hat{ }10\hat{ }1 |
| 59\hat{ }20\hat{ }2 | 45\hat{ }60\hat{ }2 | 39\hat{ }41\hat{ }1 | 11\hat{ }27\hat{ }1 | |
| 05\hat{ }20\hat{ }3 | 37\hat{ }60\hat{ }3 | 47\hat{ }13\hat{ }1 | 38\hat{ }27\hat{ }2 | |
| 14\hat{ }20\hat{ }4 | 24\hat{ }60\hat{ }4 | 39\hat{ }13\hat{ }2 | 38\hat{ }52\hat{ }1 | |
| 06\hat{ }20\hat{ }5 | 41\hat{ }60\hat{ }5 | 19\hat{ }72\hat{ }1 | | |
| 08\hat{ }20\hat{ }6 | 13\hat{ }59\hat{ }1 | 22\hat{ }67\hat{ }1 | | |
| 02\hat{ }20\hat{ }7 | 72\hat{ }59\hat{ }2 | 27\hat{ }76\hat{ }1 | | |
| 44\hat{ }20\hat{ }8 | 26\hat{ }05\hat{ }1 | 52\hat{ }09\hat{ }1 | | |
| | 31\hat{ }05\hat{ }2 | 55\hat{ }63\hat{ }1 | | |
| | 67\hat{ }14\hat{ }1 | 28\hat{ }63\hat{ }2 | | |
| | 35\hat{ }06\hat{ }1 | 10\hat{ }11\hat{ }1 | | |
| | 76\hat{ }08\hat{ }1 | | | |
| | 09\hat{ }08\hat{ }2 | | | |
| | 63\hat{ }02\hat{ }1 | | | |
| | 77\hat{ }02\hat{ }2 | | | |
| | 11\hat{ }44\hat{ }1 | | | |

The columns of the above string matrix are strings obtained by querying recursively at each time, it will be appreciated the generated string matrix is not limited to arranged in the above way, several other arranging ways, for example, setting the rows of the above string matrix are strings obtained by querying recursively at each time, are all fall in the scope of the present invention.

4. Display Module

In the display module, provides a method for displaying the query result obtained through the above database query method, comprises the following steps:

Display elements corresponding to storage elements are set in the node storage module, meanwhile said display elements are recorded in the node storage module, therein said storage elements contain node identifiers, associated levels, numbers for associations in each level;

After the data matrix of recursive query is obtained, the display element matched with each storage element is found in the node storage module according to storage elements recorded in the data matrix;

Displaying the display elements, thereby the associated model represented by string matrix is displayed.

Specifically, in order to display the query results, display elements corresponding to storage elements, such as node identifiers, associated levels and numbers for associations in each level and the like, may be set in the node storage module, meanwhile said display elements are recorded in the node storage module. So that related display elements can be called according to the matched relationship of the display elements and node identifiers, types of associated models, numbers of associated layers and levels, and be displayed.

After the data matrix of recursive query is obtained, the display element matched with each storage element is found in the node storage module according to storage elements recorded in the data matrix (for example, node identifiers, associated levels and numbers for associations in each level, etc.), and the display elements are displayed with various presentation software (such as, FLASH, PHOTOSHOP), thus associated models represented by the string matrix are displayed. Then final query results of the relational model in multi-dimensional database can be returned in the client. The state displayed to user by the client is similar to the module shown in FIG. 6. Furthermore, display module of detail information may be inserted to the display module of the client, when each node is clicked, the detail information related to this node can be displayed in the display module of detail information, so that the user can experience a feeling of navigation query. Different elements may be displayed differently with different display elements, such as colors, resolutions and the like.

“A embodiment” or “embodiments” and the like described in the specification indicate that certain features, structures or characters described in connection with the embodiment are contained in at least one of implementations covered in the present invention. Therefore, appearing of words “a embodiment” or “embodiments” and the like, not necessarily means the same embodiment. In addition, certain features, structures or characters may be created in other suitable forms which are different from said certain embodiment, and all this kind of forms can be covered by the present invention.

Although the present invention has been described with reference to specific exemplary embodiments, it will be evident to one of ordinary skill in the art that various modifications and changes may be made to the invention without departing from the broader spirit and scope of the invention (various modifications and combinations may be made to each technical solution and technical features thereof without departing from the broader spirit and scope of the invention), and these modifications and changes are deemed to fall in the scope of the present invention.

What is claimed is:

1. A method for identifying and anti-identifying used in the database, said database contains individuals, the individuals are divided logically into principals and receptors,
the identifying step comprising: inserting, updating and deleting information of the principals;
the anti-identifying step comprising:
1) querying information of the receptors in the database;
2) forming information needed to apply to the receptors according to the information of the principals if the receptors are queried, and inserting, updating and deleting the formed information for the receptors according to the inserting, updating and deleting of the information of the principals for the principals;
3) if the receptors are not found in the database, inserting information corresponding to the receptors in individual tables, and then inserting the corresponding information into some field of the corresponding row of the receptors.

2. The method of claim 1, wherein the step of forming information needed to apply to the receptors comprises the following steps:
querying states occurred to the principals by the receptors corresponding to states occurred to the receptors by the principals in the state storage module;
adjusting the locations of receptors and principals according to the queried the states occurred to the principals by the receptors, and combining the states with fixed information in the information of principals in a preset orderso as to form information needed to be inserted in some field of the corresponding row of the receptors.

3. A method for identifying and anti-identifying entity tables in the database, wherein the entities corresponding to the entity tables are divided logically into principals and receptors,
the identifying step comprising: storing, updating or deleting the identifiers of associated entities associated with entities in the entity tables in associated entity module of the entity table corresponding to principals;
the step of anti-identifying entity tables corresponding to receptors may comprising:
searching entity tables corresponding to said associated entities through identifiers of the associated entities;
if corresponding entity tables are searched, then storing, updating or deleting identifiers of the entities in the associated entity modules of the entity tables corresponding to the associated entities; if corresponding entity tables are not searched, storing or updating operations are made in the associated entity modules of the entity tables, then creating entity tables for the associated entities, and storing or updating identifiers of the entities in the associated entity modules of the entity tables created for the associated entities.

4. A method for identifying state tables in the database, comprising:
inserting states in state storage modules;
if there are reverse states corresponding to the states, inserting the reverse states in state storage modules, then storing, updating or deleting states occurred by the main entities and the associated entities in the state tables in the associated state module of the state table, and then storing, updating or deleting occurring time of the states in the time-dimensional module of the state tables, wherein the state storage modules are defined in the database to store states occurred by the entities themselves, each state occurred between entities and reverse state corresponding to each state occurred between entities;
the step of anti-identifying state tables comprising:
searching state tables corresponding to said associated entities through identifiers of the associated entities and searching reverse states in state storage modules;
if corresponding state tables and matched reverse states are searched, then storing, updating or deleting the states occurred by the main entities and the associated entities in the associated state modules of the state tables corresponding to the associated entities using searched reverse states, and storing, updating or deleting occurring time of the states in the time-dimensional module of the state tables corresponding to the associated entities;
if corresponding state tables are not searched, storing or updating operations are made in the associated entity modules of the state tables of the main entities, then creating state tables for the associated entities, and storing or updating the states occurred by the main entities and the associated entities in the associated state modules in the state tables created for the associated entities using searched reverse states, and storing or updating occurring time of the states in the time-dimensional module of the state tables corresponding to the associated entities.

5. The method of any one of claims 1-4, wherein the anti-identifying step is automatically proceeded following the identifying operation.

6. A method for querying associated models in the database included associated models, which comprises the following steps:
1) sending query instructions for the entity and association model by a user;
2) judging whether the entity is stored in a node storage module, if not, returning a null query value, if yes, then entering step 3).
3) judging whether there exists a node having a first-level associated with the node that corresponds to the entity, if not, returning non-association query value, if yes, then querying recursively in the recursive query module.

7. The method of claim 6, wherein the step of recursion query comprises the following steps:
a) querying the first-level association node of the node corresponding to the entity, reading the node ID and numbering each association of the first-level, wherein association level is assigned value 1;
b) generating an association string according to the node ID, association level and association number, and then storing the string in a storage;
c) judging whether there exist lower level recursion, if yes, then enter step d), if not, then enter step e);
d) querying the first-level association node of the node corresponding to the association entity associated with the association level, reading the node ID and numbering each association of the level, wherein association level is assigned association level+1, returning to step b);
e) reading the string in the storage, and generating a string matrix.

8. The method of claim 6 or 7, wherein after completing the recursion query, transmitting the string matrix to a display module.

9. The method of claim 7, wherein judging whether there exist lower level recursion can be achieved by querying whether the first-level association node of the node corresponding to the association entity associated with the association level is existed.

10. A method for displaying the query result obtained through the query method as described in claims 6-9, comprises the following steps:
setting display elements corresponding to storage elements in the node storage module, meanwhile said display elements are recorded in the node storage module, said storage elements contain node identifiers, associated levels, numbers for associations in each level;
finding display element matched with each storage element in the node storage module according to storage elements recorded in the data matrix after the data matrix of recursive query is obtained;
displaying the display elements so as to display the associated model represented by string matrix.
